(19) United States
(12) Patent Application Publication
(10) Pub. No.: US 2025/0260546 A1
(43) Pub. Date: Aug. 14, 2025

(54) HARQ FEEDBACK CONTROL WITH RELIABILITY ENHANCEMENT

(71) Applicant: APPLE INC., Cupertino, CA (US)

(72) Inventors: Chunhai Yao, Beijing (CN); Chunxuan Ye, San Diego, CA (US); Dawei Zhang, Saratoga, CA (US); Oghenekome Oteri, San Diego, CA (US); Fangli Xu, Beijing (CN); Hong He, San Jose, CA (US); Wei Zeng, San Diego, CA (US); Yushu Zhang, Beijing (CN); Huaning Niu, San Jose, CA (US); Seyed Ali Akbar Fakoorian, San Diego, CA (US)

(21) Appl. No.: 18/858,012

(22) PCT Filed: Apr. 25, 2022
(86) PCT No.: PCT/CN2022/088932

§ 371 Date: Oct. 18, 2024

(51) Int. Cl. H04L 5/00; H04L 1/1829; H04L 12/18

(52) U.S. Cl. CPC H04L 5/0055; H04L 1/1854; H04L 12/1868

(57) ABSTRACT

The present disclosure is related to techniques for Hybrid Automatic Repeat Request (HARQ) feedback control which can be used with a multicast service or any group-based service. In an embodiment, a UE is configured to decode a first DCI and a second DCI by using a first group identification (ID) to obtain a first downlink assignment index (DAI) and a second DAI respectively; decode a first PDSCH reception scheduled by the first DCI to generate a first HARQ bit, and decode a second PDSCH reception scheduled by the second DCI to generate a second HARQ bit; and arrange the first and the second HARQ bits for the first and the second PDSCH receptions in a first HARQ codebook, wherein a first position of the first HARQ bit in the first HARQ codebook is indicated by a first counter DAI (C-DAI) included in the first DAI, and a second position of the second HARQ bit in the first HARQ codebook is indicated by a second C-DAI included in the second DAI.

### TECHNICAL FIELD

This application relates generally to wireless communication systems and methods, including wireless communication devices and methods for Hybrid Automatic Repeat Request (HARQ) feedback control which can be used with a multicast service or any group-based service.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Some exemplary embodiments are related to a user equipment device (UE) having one or more antennas, a transceiver, and a processor. The one or more antennas are configured to perform wireless communications. The transceiver is coupled to the one or more antennas, and the processor is coupled to the transceiver and configured to cause the UE to perform operations related to HARQ feedback. The operations include, for one or more downlink control information (DCIs) received from a base station and for one or more multicast PDSCH receptions from the base station scheduled by the respective DCIs, decoding a first DCI and a second DCI by using a first group identification (ID) to obtain a first downlink assignment index (DAI) and a second DAI respectively; decoding a first PDSCH reception scheduled by the first DCI to generate a first Hybrid Automatic Repeat Request (HARQ) bit, and decoding a second PDSCH reception scheduled by the second DCI to generate a second HARQ bit; and arranging the first and the second HARQ bits for the first and the second PDSCH receptions in a first HARQ codebook to generate a first ACK/NACK feedback, wherein a first position of the first HARQ bit in the first HARQ codebook is indicated by a first counter DAI (C-DAI) included in the first DAI, and a second position of the second HARQ bit in the first HARQ codebook is indicated by a second C-DAI included in the second DAI.

Other exemplary embodiments are related to a base station having one or more antennas, a transceiver, and a processor. The one or more antennas are configured to perform wireless communications. The transceiver is coupled to the one or more antennas, and the processor is coupled to the transceiver and configured to cause the base station to perform operations related to HARQ feedback. The operations include receiving, from a base station, a measurement configuration comprising a measurement period for performing measurements on one or more carriers. The operations include transmitting a first downlink control information (DCI) to a group of user equipment devices (UEs), wherein the first DCI is scrambled with a first group identification (ID) and includes a first downlink assignment index (DAI), and the first DCI is configured to schedule a first PDSCH transmission; transmitting a second DCI to the group of UEs, wherein the second DCI is scrambled with the first group ID and includes a second DAI, and the second DCI is configured to schedule a second PDSCH transmission; determining a first position of a first HARQ bit for the first PDSCH transmission in a first HARQ codebook based on a first C-DAI included in the first DAI, and a second position of the second HARQ bit for the second PDSCH transmission in the first HARQ codebook based on a second C-DAI included in the second DAI; and decoding HARQ information received from a first UE in the group of UEs based on positions of respective HARQ bits.

Some exemplary embodiments are related to a UE having one or more antennas, a transceiver, and a processor. The one or more antennas are configured to perform wireless communications. The transceiver is coupled to the one or more antennas, and the processor is coupled to the transceiver and configured to cause the UE to perform operations related to coordinate resources for HARQ feedback and a scheduling request (SR). The operations include transforming NACK-only feedback to ACK/NACK feedback; and multiplexing the transformed ACK/NACK feedback with a SR to obtain a multiplexed signal.

Some exemplary embodiments are related to a UE having one or more antennas, a transceiver, and a processor. The one or more antennas are configured to perform wireless communications. The transceiver is coupled to the one or more antennas, and the processor is coupled to the transceiver and configured to cause the UE to perform operations related to coordinate resources for HARQ feedback and a scheduling request (SR). The operations include generating a NACK-only feedback for one or more PDSCH receptions associated with a first group identification (ID), wherein the NACK-only feedback is to be transmitted along with a first ACK/NACK feedback in a same first slot; transforming the NACK-only feedback to a second ACK/NACK feedback; and transmitting the first and the second ACK/NACK feedbacks in the first slot. The first ACK/NACK feedback is generated either for one or more PDSCH receptions associated with a second group ID or for one or more PDSCH receptions in a unicast service.

These and other objects, features and advantages of the exemplary embodiments of the present disclosure will become apparent upon reading the following detailed description of the exemplary embodiments of the present disclosure.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates a flow diagram of a method for communication between a base station and a group of UEs, according to embodiments disclosed herein.

FIG. 4A illustrates a flow diagram of a method for HARQ feedback configuration at a base station, according to embodiments disclosed herein.

FIG. 4B illustrates examples of HARQ feedback configuration at a base station, according to embodiments disclosed herein.

FIG. 5A illustrates a flow diagram of a method for HARQ feedback construction at a UE, according to embodiments disclosed herein.

FIG. 5B illustrates examples of HARQ codebook construction at a UE, according to embodiments disclosed herein.

FIG. 6 illustrates a flow diagram of a method for HARQ feedback decoding at a base station, according to embodiments disclosed herein.

FIG. 7A illustrates examples of HARQ codebook construction for multiple multicast services, according to embodiments disclosed herein.

FIG. 7B illustrates further examples of HARQ codebook construction for multiple multicast services, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

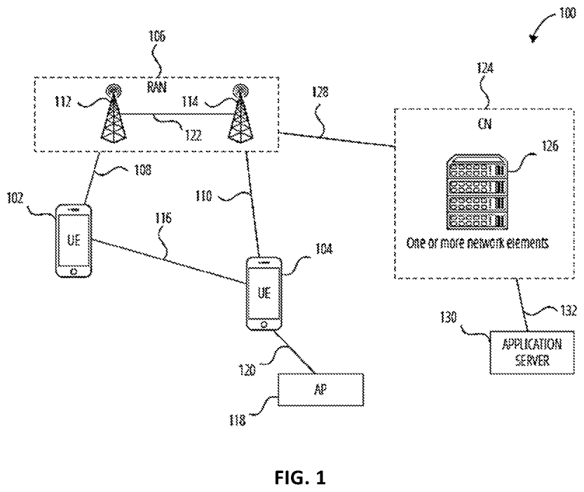

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

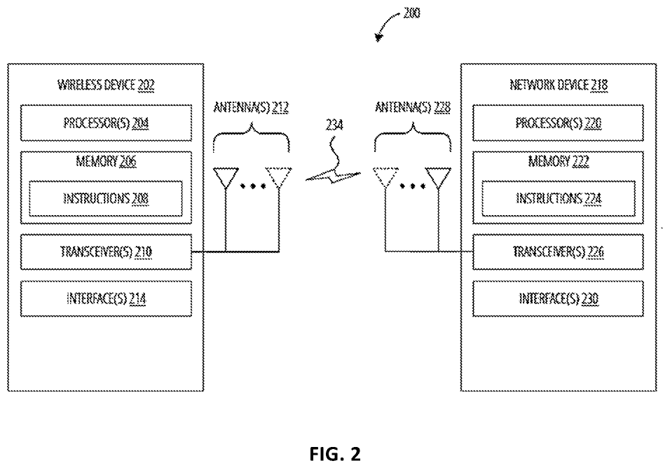

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### HARQ Feedback Control for Multicast Service or Group-Based Service

HARQ is a combination of high-rate forward error correction (FEC) and automatic repeat request (ARQ) error-control. As with many unicast services, HARQ is import for the reliability of multicast and broadcast services, or generally group-based services. In an example, a first group-based service is a service delivered to a first group of users ordered the same content, a second group-based service is a service delivered to a second group of users having the same Modulation and Code Scheme (MCS). Improvements on the HARQ feedback control in accordance with the present disclosure will be described below, which can be useful for achieving a level of reliability based on the requirements of each multicast service or group-based service. Descriptions in the context of the multicast service can equally apply to implementations for any other group-based service.

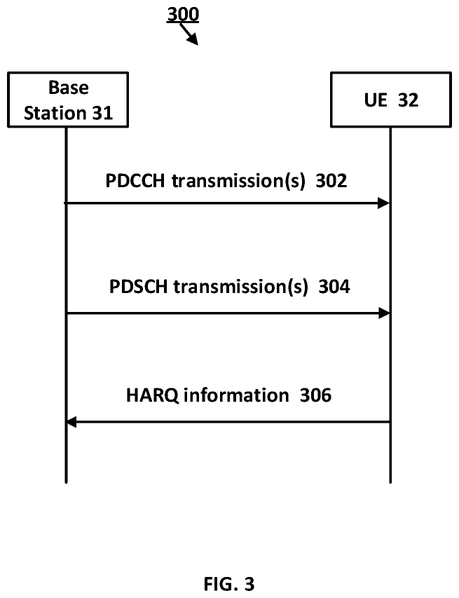

FIG. 3 illustrates a flow diagram of a method 300 for communication between a base station and a group of UEs, according to embodiments disclosed herein. The method 300 can be performed by the wireless device or the UE and the base station as shown in or described in relation to FIGS. 1 and 2. Although it is depicted operations in relation to just one UE in FIG. 3, operations in relation to other UEs in the group can be understood in the same or similar manner.

As shown by FIG. 3, at 302, the base station 31 can transmit to the UE 32 one or more PDCCHs for scheduling one or more PDSCHs transmissions. In general, a PDCCH can be mapped to first one or more OFDM symbols in every downlink subframe, and a PDCCH can be modulated by using QPSK. A PDCCH can carry downlink control information (DCI) and the DCI can carry the transport format, resource allocation, and HARQ control information related to a PDSCH transmission. A PDCCH can also carry a DCI for uplink scheduling assignment (e.g. UL Grants).

In some embodiments disclosed herein, the DCI can include a downlink assignment index (DAI) as a type of HARQ control information. In an embodiment, the DAI can include a counter DAI (C-DAI for short hereinafter), or further include a total DAI (T-DAI for short hereinafter). The DCI can be of DCI Format 4_2. In an embodiment, the DCI is scrambled by an identification (ID) of the group of UEs. An example of the group ID is a Group RNTI (G-RNTI), which will be also used in the following description.

The UE 32 can receive each PDCCH from respective OFDM symbols in the downlink subframe, and decode a DCI from the PDCCH by using the group ID thus obtaining elements included in the DCI. Since the group ID is shared by the UEs of the group, other UEs can also decode the DCI and obtain elements included in the DCI in the same manner.

As shown by FIG. 3, at 304, the base station 31 can transmit to the UE 32 one or more PDSCHs. Each PDSCH is scheduled by a respective PDCCH at 302. The UE 32 can receive the PDSCH at a monitoring occasion and generate HARQ information from decoding of the PDSCH. In particular, the UE 32 generates a HARQ bit of “ACK” from a successful decoding or a HARQ bit of “NACK” from a failed decoding. The HARQ bits for respective PDSCH receptions can be arranged into a HARQ codebook in a specific sequence.

As shown by FIG. 3, at 306, the UE 32 can transmit to the base station 31 HARQ information in the HARQ codebook. The base station 31 can decode HARQ information received from a first wireless device in the group of wireless devices by using the first HARQ codebook. In response to an ACK feedback in a HARQ process, the base station 31 will schedule a new transmission in the HARQ process; in response to a NACK feedback in a HARQ process, the base station 31 will schedule a re-transmission in the HARQ process. That is, in order to deliver the service to the group of UEs at a desired level of reliability, it is important for the base station to decode the HARQ information from the UEs in a correct manner. In an embodiment, the HARQ information is transmitted over PUCCH or PUSCH resources.

### HARQ Feedback Configuration at Base Station

In an embodiment, for a first multicast service associated with a first G-RNTI, a base station can schedule multiple PDSCH transmissions (e.g. transport blocks (TBs)) in part or all of downlink slots within a first K1 set. In particular, each PDSCH transmission is scheduled by a PDCCH (or a DCI included therein) transmission. Each PDSCH transmission in these downlink slots within the first K1 set will produce a respective HARQ bit, and all HARQ bits for PDSCH transmissions in these slots will be fed back to the base station in a first uplink slot.

In an embodiment, for a second multicast service associated with a second G-RNTI, a base station can schedule multiple PDSCH transmissions in another part of downlink slots within the same first K1 set. Again, each PDSCH transmission can be scheduled by a PDCCH (or a DCI included therein) transmission. Each PDSCH transmission in these downlink slots within the first K1 set will produce a respective HARQ bit, and all HARQ bits for PDSCH transmissions in these slots will be fed back to the base station in a same first uplink slot as HARQ bits for the first multicast service above.

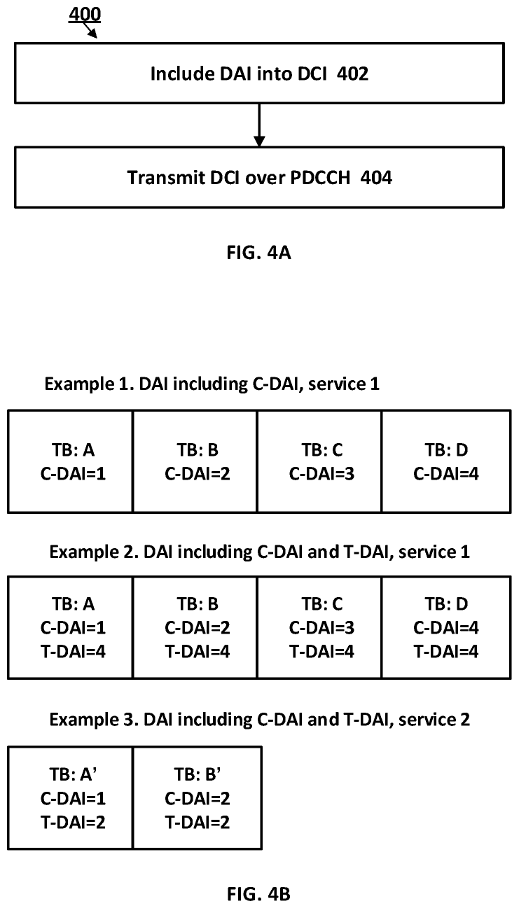

FIG. 4A illustrates a flow diagram of a method 400 for HARQ feedback configuration at a base station, according to embodiments disclosed herein. The method 400 can be performed by the base station as shown in or described in relation to FIGS. 1 and 2. The method 400 can configure the HARQ feedback for downlink slots within each K1 set and for multicast services associated with a first and a second G-RNTIs.

As shown by FIG. 4A, at 402, for a multicast service associated with a G-RNTI, a base station can include a DAI into a DCI which is to schedule a PDSCH transmission in a downlink slot within a K1 set. In an embodiment, the DAI includes a C-DAI which is a counter of DAIs for the multicast service within a K1 set. Additionally, the DAI can include a T-DAI which is a total number of DAIs for the multicast service within the K1 set. The C-DAI increases as the counter for DAIs within the K1 set, and the T-DAI is the same for all DAIs in the K1 set. The operations at 402 can be better understood with reference to examples depicted in FIG. 4B.

FIG. 4B illustrates examples of HARQ feedback configuration at a base station, according to embodiments disclosed herein. Referring to FIG. 4B, in the example 1 and example 2, for multicast service 1 associated with G-RNTI 1, the base station schedules transmissions of 4 TBs (i.e., TB A to TB D) in 4 downlink slots within a K1 set. The 4 downlink slots can be part or all of downlink slots within the K1 set. Each transmission of the TB is scheduled by a PDCCH (or a DCI included therein) transmission. In example 1, each DAI includes just a C-DAI, the values of C-DAIs for the 4 TBs increase from 1 to 4. In example 2, each DAI includes a C-DAI and a T-DAI, the values of C-DAIs for the 4 TBs increase from 1 to 4 similarly, and the values of T-DAIs for the 4 TBs are the same (i.e., 4).

In example 3, for multicast service 2 associated with G-RNTI 2, the base station schedules transmissions of 2 TBs (i.e., TB A′ to TB B′) in another 2 downlink slots within the same K1 set. Example 3 shows each DAI can include both a C-DAI and a T-DAI, the values of C-DAIs for the 2 TBs increase from 1 to 2, and the values of T-DAIs for the 2 TBs are the same (i.e., 2). In some cases, a DAI including just a C-DAI can also be applicable to multicast service 2, although not shown in FIG. 4B. In other examples, the number of TBs which can be transmitted for one or more multicast services within a K1 set can vary depending on scenarios.

In an embodiment, at 402, a DCI (along with its CRC, if any) for the first multicast service can be scrambled with a first G-RNTI associated, and a DCI (along with its CRC, if any) for the second multicast service can be scrambled with a second G-RNTI associated similarly.

As shown by FIG. 4B, at 404, the base station can transmit, to a group of UEs for the multicast service, the multiple DCIs including respective DAIs over the PDCCHs. The DCIs can be scrambled with a G-RNTI associated the multicast service, so that the UEs for the multicast service can obtain the DCIs by using the corresponding G-RNTI.

In an embodiment, a DAI is of 2 bits to serve as a C-DAI. In another embodiment, a DAI is of 4 bits, 2 MSBs of the 4 bits can serve as a C-DAI, and 2 LSBs of the 4 bits can serve as a T-DAI; or vice versa.

### HARQ Feedback Construction at UE

In some embodiments disclosed herein, HARQ feedback construction at a UE can include HARQ codebook construction and HARQ bits arrangement in the HARQ codebook for the PDSCH receptions in a K1 set. By HARQ codebook construction, at least a number of HARQ bits in the HARQ codebook (or a size of the HARQ codebook) can be determined. HARQ bits arrangement can include determining a sequence or ordering of the HARQ bits (or positions for the HARQ bits) in the HARQ codebook.

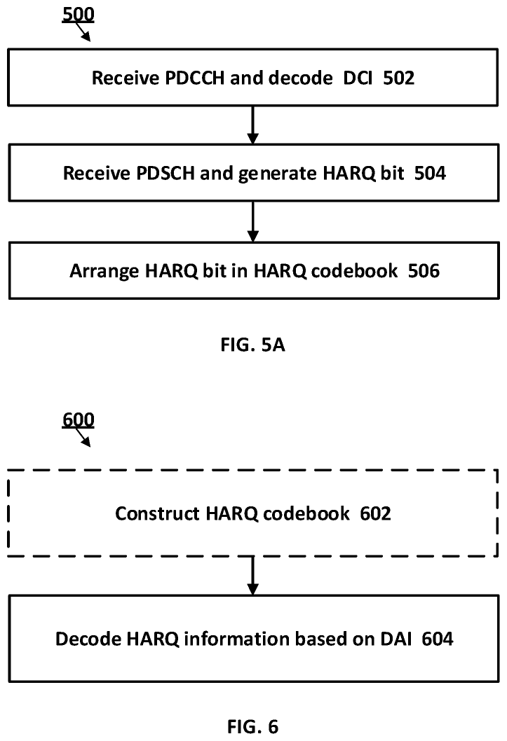

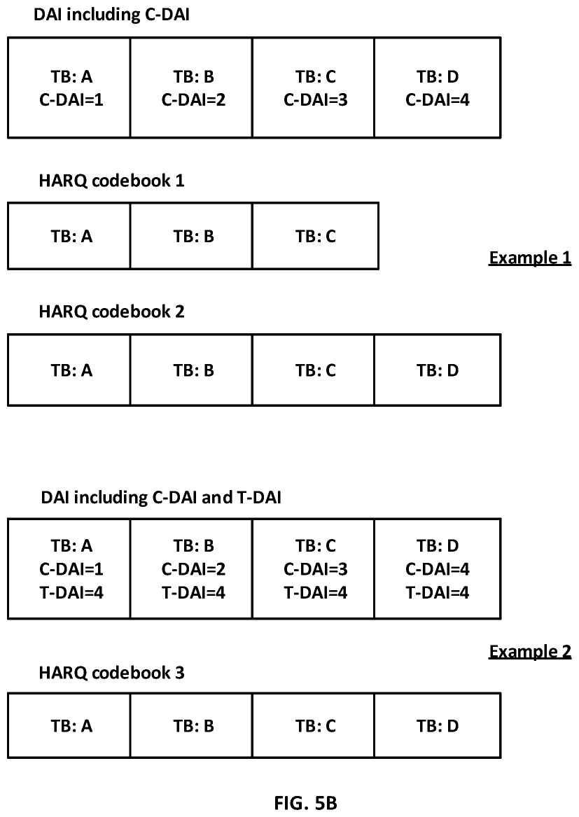

FIG. 5A illustrates a flow diagram of a method 500 for HARQ feedback construction at a UE, according to embodiments disclosed herein. The method 500 can be performed by the wireless device or the UE as shown in or described in relation to FIGS. 1 and 2. The method 500 can construct the HARQ feedback for downlink slots within a K1 set and for a multicast service associated with a G-RNTI.

As shown by FIG. 5A, at 502, a UE can receive one or more PDCCHs and decode DCI(s) included therein. In an embodiment, the UE can decode the DCI by using a G-RNTI associated a multicast service. The UE can further obtain the C-DAI and/or the T-DAI from the DCI and construct a HARQ codebook based on at least one of the C-DAI or the T-DAI. In an example, the size of the HARQ codebook can be determined based on a maximum value of C-DAIs, or based on the same T-DAI included in multiple DAIs. The operations at 502 can be better understood with reference to examples depicted in FIG. 5B.

FIG. 5B illustrates examples of HARQ codebook construction at a UE, according to embodiments disclosed herein. Referring to example 1, which is a continuation of example 1 in FIG. 4B, for multicast service 1 associated with G-RNTI 1, if the C-DAI=3 is the C-DAI of the maximum value received by the UE, the UE can determine the number of the HARQ bits in the HARQ codebook 1 is 3. Accordingly, the benefits from the C-DAI at least lie in it can preserve positions in the HARQ codebook for HARQ bits corresponding to C-DAIs with smaller values. In this example, the size of the HARQ codebook is determined as 3 even if the UE does not receive one or more previous PDCCHs (or DCIs, DAIs therein). If the C-DAI=4 is the C-DAI of the maximum value received by the UE, the UE can determine the number of the HARQ bits in the HARQ codebook 2 is 4.

Referring to example 2, which is a continuation of example 2 in FIG. 4B, for multicast service 1 associated with G-RNTI 1, if the T-DAI-4 is received by the UE from at least one PDCCH reception, the UE can determine the number of the HARQ bits in the HARQ codebook 3 is 4. Accordingly, the benefits from the T-DAI at least lie in it can preserve positions in the HARQ codebook for HARQ bits corresponding to all DAIs. In this example, the size of the HARQ codebook is determined as 4 even if the UE just receives one PDCCH (or the DCI, DAI therein).

As shown by FIG. 5A, at 504, the UE can receive one or more PDSCHs at monitoring occasions and generate HARQ bits accordingly. The UE generates a HARQ bit of “ACK” for a successful decoding or a HARQ bit of “NACK” for a failed decoding.

As shown by FIG. 5A, at 506, the UE can arrange HARQ bit in HARQ codebook to generate the HARQ feedback. The HARQ bits for respective PDSCH receptions can be arranged into a HARQ codebook in a specific sequence. As can be seen in FIG. 4B, each TB transmission is associated with a C-DAI. A position of a HARQ bit for the TB in the HARQ codebook is indicated by a C-DAI included in the DAI. In an embodiment, after arranging each HARQ bit in the HARQ codebook, the UE can determine if any position in the HARQ codebook is empty without a HARQ bit (i.e. ACK or NACK), and can fill a NACK bit in such positions. Table 1 below shows examples of HARQ feedback under some exemplary scenarios. In Table 1, the filled NACK bit is underlined to distinguish over other HARQ bits.

TABLE 1
Examples of HARQ bit arrangement

| | Scenario | HARQ Feedback |
|---|---|---|
| 1 | HARQ codebook 1 in FIG. 5B, | ACK, NACK, ACK |
| | i.e., DCI for TB D missing; | |
| | no other DCIs missing | |
| 2 | HARQ codebook 1 in FIG. 5B, | NACK, NACK, ACK |
| | i.e., DCI for TB D missing; | |
| | DCI for TB A missing | |
| 3 | HARQ codebook 2 in FIG. 5B; | ACK, NACK, ACK, ACK |
| | no DCIs missing | |
| 4 | HARQ codebook 2 in FIG. 5B; | NACK, NACK, ACK, ACK |
| | DCI for TB A missing | |
| 5 | HARQ codebook 3 in FIG. 5B; | ACK, NACK, ACK, ACK |
| | no DCIs missing | |
| 6 | HARQ codebook 3 in FIG. 5B; | ACK, NACK, NACK, ACK |
| | DCI for TB C missing | |

### HARQ Feedback Decoding at Base Station

In some embodiments disclosed herein, HARQ feedback decoding at a base station can include decoding HARQ bits in the HARQ codebook for the PDSCH transmissions in a K1 set. FIG. 6 illustrates a flow diagram of a method 600 for HARQ feedback decoding at a base station, according to embodiments disclosed herein. The method 600 can be performed by the base station as shown in or described in relation to FIGS. 1 and 2. The method 600 can decode the HARQ feedback for downlink slots within a K1 set and for a multicast service associated with a G-RNTI.

As shown by FIG. 6, at 604, the base station can decode HARQ information based on respective DAIs, in particular, C-DAIs included therein. Table 2 below shows examples of HARQ feedback decoding under some exemplary scenarios listed in Table 1.

TABLE 2
Examples of HARQ bit decoding

| | | | Decoded HARQ |
|---|---|---|---|
| | Scenario | HARQ Feedback | Feedback |
| 1 | HARQ codebook 1 in | ACK, NACK, ACK | ACK, NACK, ACK |
| | FIG. 5B, i.e., DCI | | |
| | for TB D missing; | | |
| | no other DCIs missing | | |
| 2 | HARQ codebook 1 in | NACK, NACK, | NACK, NACK, |
| | FIG. 5B, i.e., DCI | ACK | ACK |
| | for TB D missing; | | |
| | DCI for TB A missing | | |
| 3 | HARQ codebook 2 in | ACK, NACK, | ACK, NACK, ACK, |
| | FIG. 5B; no DCIs | ACK, ACK | ACK |
| | missing | | |
| 4 | HARQ codebook 2 | NACK, NACK, | NACK, NACK, |
| | in FIG. 5B; DCI | ACK, ACK | ACK, ACK |
| | for TB A missing | | |
| 5 | HARQ codebook 3 | ACK, NACK, | ACK, NACK, ACK, |
| | in FIG. 5B; no | ACK, ACK | ACK |
| | DCIs missing | | |
| 6 | HARQ codebook 3 | ACK, NACK, | ACK, NACK, |
| | in FIG. 5B; DCI | NACK, ACK | NACK, ACK |
| | for TB C missing | | |

As shown by FIG. 6, in some embodiments, at 602, the base station can optionally construct a HARQ codebook which may include determining a size of the HARQ codebook. For example, the size of the HARQ codebook can be determined based on the value of T-DAI. With the size information, the base station can correctly identify each HARQ codebook (or sub-codebook) from multiple HARQ codebooks (or from the whole HARQ codebook). In addition, as shown by Table 3, for scenarios 1 and 2, the last NACK (in bold) bit can be decoded corresponding to the missing DCI for TB D based on the size information.

TABLE 3
Examples of HARQ bit decoding

| | | | Decoded HARQ |
|---|---|---|---|
| | Scenario | HARQ Feedback | Feedback |
| 1 | HARQ codebook 1 in | ACK, NACK, ACK | ACK, NACK, ACK, |
| | FIG. 5B, i.e., DCI | | NACK |
| | for TB D missing; | | |
| | no other DCIs missing | | |
| 2 | HARQ codebook 1 in | NACK, NACK, | NACK, NACK, |
| | FIG. 5B, i.e., DCI | ACK | ACK, NACK |
| | for TB D missing; | | |
| | DCI for TB A missing | | |

### HARQ Feedback for Multiple Multicast Services

As mentioned above, in some embodiments, for multiple multicast services associated with different G-RNTIs, a base station can schedule multiple PDSCH transmissions (e.g. transport blocks (TBs)) in downlink slots within a same K1 set. In particular, each PDSCH transmission is scheduled by a PDCCH (or a DCI included therein) transmission associated with a G-RNTI. PDSCH transmissions for the multiple multicast services in these downlink slots within the first K1 set will produce a HARQ feedback to the base station in a same uplink slot. In such embodiments, a HARQ sub-codebook can be constructed for PDSCH transmissions for each G-RNTI, and multiple HARQ sub-codebooks can be appended to one another in an ascending order or a descending order of the G-RNTIs. As can be understood, each HARQ sub-codebook can be constructed at a UE as illustrated in FIGS. 5A and 5B, and can be decoded at a base station as illustrated in FIG. 6.

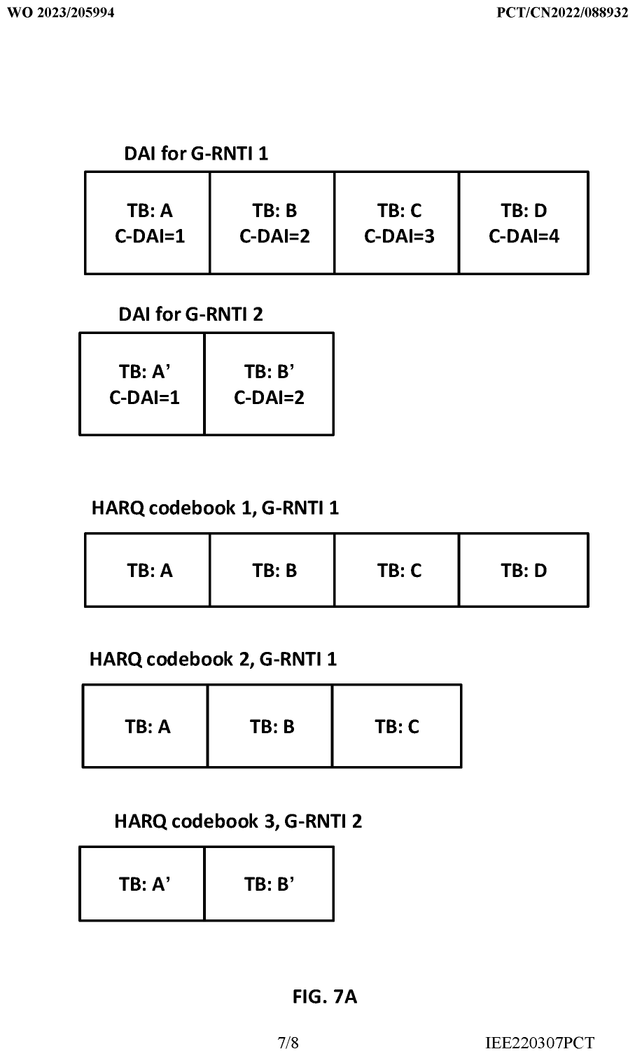

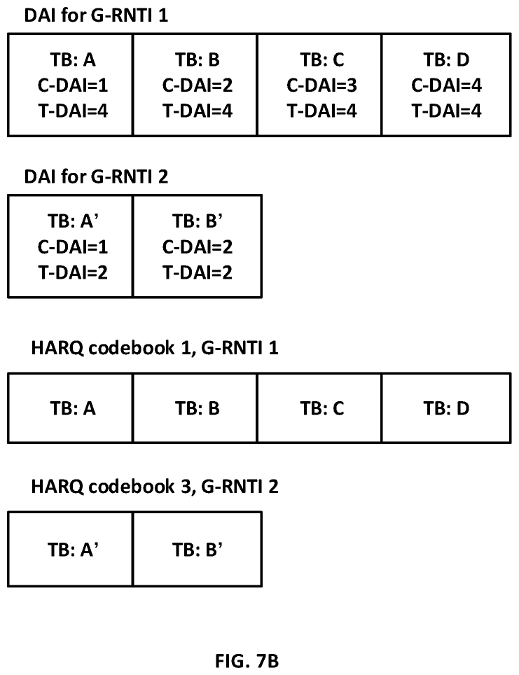

FIG. 7A illustrates examples of HARQ codebook construction for multiple multicast services, according to embodiments disclosed herein. In this example, G-RNTI 1 is associated with a first multicast service, and G-RNTI 2 is associated with a second multicast service. The DAIs for each G-RNTI include just a C-DAI as can be seen in FIG. 7A. When no DCI missing occurs, the HARQ codebook 1 can be constructed for G-RNTI 1, and the HARQ codebook 3 can be constructed for G-RNTI 2. Each size of HARQ codebook 1 or HARQ codebook 3 is determined based on the maximum value of C-DAI, thus the size is consistent with assumptions at the base station. Accordingly, there is no problem for the base station to decode a HARQ feedback which is produced based on the combination of HARQ codebook 1 and HARQ codebook 3 (with either HARQ codebook 3 appended to HARQ codebook 1, or the other way).

When the last one or more DCI is missing, there will be problem for the above HARQ feedback decoding. For example, as can be seen in FIG. 7A, when the last DCI for TB D is missing for G-RNTI 1, C-DAI=3 will be the maximum value in the DCIs received by the UE. Accordingly, the UE will construct a HARQ codebook 2 with 3 HARQ bits for G-RNTI 1. While the base station assumes 4 HARQ bits in the sub-codebook for G-RNTI 1, problems may arise when the base station cannot distinguish HARQ bits for each G-RNTI in the whole HARQ codebook.

FIG. 7B illustrates further examples of HARQ codebook construction for multiple multicast services, according to embodiments disclosed herein. Compared with FIG. 7A, the DAIs for each G-RNTI include both a C-DAI and a T-DAI, where the T-DAI can help to solve the problems which may arise in FIG. 7A and to further improve reliability of HARQ feedback decoding. In this example, as long as one DCI is received for G-RNTI 1, a HARQ codebook of 4 bits will be constructed based on the value of T-DAI=4 in the received DCI. Similarly, as long as one DCI is received for G-RNTI 2, a HARQ codebook of 2 bits will be constructed based on the value of T-DAI=2 in the received DCI. In this manner, the size of the HARQ codebook is always consistent with the assumption at the base station, the base station can decode HARQ bits for each G-RNTI without confusion, which will ensure the base station will schedule new transmission or re-transmission correctly and efficiently.

When all DCIs for a specific G-RNTI are missing, there will be problem for the above HARQ feedback decoding even with the T-DAI. For example, as can be seen in FIG. 7B, when both DCIs for TBs A and B are missing for G-RNTI 2, the UE will have no information to construct a HARQ codebook for G-RNTI 2, and will only construct the HARQ codebook for G-RNTI 1. While the base station assumes sub-codebooks for both G-RNTI 1 and G-RNTI 2, problems may arise when the base station actually receives just the HARQ codebook for G-RNTI 1. In an embodiment, the UE can receive an uplink DAI (UL DAI) in a UL grant, for example. The UL DAI can indicate a total number of downlink DAIs (DL DAIs) for all groups of UEs, for example, for UEs associated with both G-RNTI 1 and G-RNTI 2. In this example, the UL DAI=4 (T-DAI for G-RNTI 1)+2 (T-DAI for G-RNTI 2). In this way, even when the UE has no information on the T-DAI for G-RNTI 2 (due to DCIs for G-RNTI 2 are missing), the UE can infer this information from the difference between the UL DAI and the T-DAI for G-RNTI 1, and construct the HARQ codebook 3 for G-RNTI 2 based on the information.

As described above, a HARQ codebook or sub-codebook is generated for PDSCH receptions associated with a particular multicast service, instead of including HARQ information associated with multiple services into the HARQ codebook or sub-codebook. Accordingly, the base station can have better knowledge of performance of downlink transmission for the multicast service, thus can schedule new transmissions or re-transmissions in a more accurate and reliable manner.

### Further Improvements

In some embodiments, the HARQ feedback can be disabled per HARQ process, for example, via higher layer signaling such as RRC signaling or lower layer signaling. The DAI field for the type-2 HARQ codebook in case of HARQ feedback can be used to provide assistant information for HARQ codebook construction. For example, the DAI in the disabled HARQ process can be set to the same as previous value of DAI of an enabled HARQ process with the same G-RNTI. If the previous missed DCI is the last scheduled PDSCH with HARQ feedback, the DAI of disabled HARQ process could make the UE aware the previous DCI is missed. Thus, the wrong codebook construction can be avoided.

In some embodiments, G-RNTI 1 or G-RNTI 2 is a group ID configured with NACK-only HARQ feedback. In such embodiment, the NACK-only HARQ feedback is transformed to ACK/NACK feedback, the UE and the base station can construct the HARQ codebook as described above in a dynamic manner (such codebook can be named type-2 HARQ codebook). In an embodiment, the UE and the base station can construct a static HARQ codebook (such codebook can be named type-1 HARQ codebook). For the type-1 HAQR codebook, the union of time domain resource allocation (TDRA) table can be applied to determine the codebook.

In an embodiment, a UE generates a NACK-only feedback for one or more PDSCH receptions associated with a first group ID, wherein the NACK-only feedback is to be transmitted along with a first ACK/NACK feedback in a same first slot. The UE further transforms the NACK-only feedback to a second ACK/NACK feedback, and transmits the first and the second ACK/NACK feedbacks in the first slot. In an embodiment, a type-1 HARQ codebook or a type-2 HARQ codebook is applied to both the first and the second ACK/NACK feedbacks with a same priority. In an example, the type-1 HARQ codebook is determined by applying a union of a time domain resource allocation (TDRA) table. In an embodiment, one of the first or the second ACK/NACK feedbacks is appended to the other in an ascending order or a descending order of the first and the second group IDs if the second ACK/NACK feedback is generated for one or more PDSCH receptions associated with the second group ID, or the first ACK/NACK feedback is appended to the second ACK/NACK feedback if the second ACK/NACK feedback is generated for one or more PDSCH receptions in the unicast service.

In some embodiment, a UE can be configured to multiplex NACK-only feedback with a scheduling request (SR). In particular, the UE transforms NACK-only feedback to ACK/NACK feedback, and multiplexes the transformed ACK/NACK feedback with the SR to obtain a multiplexed signal. The UE can apply PUCCH resources configured for unicast to the multiplexed signal, or apply PUCCH resources configured for multicast ACK/NACK feedback to the multiplexed signal, or drop the transformed ACK/NACK feedback or the SR depending on priorities thereof.

In an embodiment, the NACK-only feedback is configured to support more than two bits of NACK-only feedback, and the UE can share PUCCH resources with the SR based on a predefined PUCCH resource table. An example of the PUCCH resource table is shown in Table 4 below, where “N” means NACK and “A” means ACK. Taking the example of 4 TBs (TB 1 to TB4), since the feedback “A, A, A, A” is not necessary for the HARQ feedback transformed from the NACK-only feedback, the PUCCH resource corresponding to the feedback “A, A, A, A” can be allocated to the SR.

TABLE 4
Example of the PUCCH resource table

| HARQ-ACK feedback | | | | PUCCH |
|---|---|---|---|---|
| TB1 | TB1, TB2 | TB1, TB2, TB3 | TB1, TB2, TB3, TB4 | resource |
| N | N, N | N, N, N | N, N, N, N | 1^{st} PUCCH |
| | | | | resource |
| | N, A | N, A, N | N, A, N, N | 2^{nd} PUCCH |
| | | | | resource |
| | A, N | A, N, N | A, N, N, N | 3^{rd} PUCCH |
| | | | | resource |
| | | N, N, A | N, N, A, N | 4^{th} PUCCH |
| | | | | resource |
| | | N, A, A | N, A, A, N | 5^{th} PUCCH |
| | | | | resource |
| | | A, N, A | A, N, A, N | 6^{th} PUCCH |
| | | | | resource |
| | | A, A, N | A, A, N, N | 7^{th} PUCCH |
| | | | | resource |
| | | | N, N, N, A | 8^{th} PUCCH |
| | | | | resource |
| | | | N, N, A, A | 9^{th} PUCCH |
| | | | | resource |
| | | | N, A, N, A | 10^{th} PUCCH |
| | | | | resource |
| | | | A, N, N, A | 11^{th} PUCCH |
| | | | | resource |
| | | | N, A, A, A | 12^{th} PUCCH |
| | | | | resource |
| | | | A, N, A, A | 13^{th} PUCCH |
| | | | | resource |
| | | | A, A, N, A | 14^{th} PUCCH |
| | | | | resource |
| | | | A, A, A, N | 15^{th} PUCCH |
| | | | | resource |

Embodiments contemplated herein include an apparatus comprising means to perform one or more elements of any of method 300, 400, 500, and 600. This apparatus may be, for example, an apparatus of a UE (such as a wireless device 202 that is a UE, as described herein) or of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of any of method 300, 400, 500, and 600. This non-transitory computer-readable media may be, for example, a memory of a UE (such as a memory 206 of a wireless device 202 that is a UE, as described herein) or of a base station (such as a memory 222 of a network device 218 that is a base station, as described herein).

Embodiments contemplated herein include an apparatus comprising logic, modules, or circuitry to perform one or more elements of any of method 300, 400, 500, and 600. This apparatus may be, for example, an apparatus of a UE (such as a wireless device 202 that is a UE, as described herein) or of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of any of method 300, 400, 500, and 600. This apparatus may be, for example, an apparatus of a UE (such as a wireless device 202 that is a UE, as described herein) or of a base station (such as a network device 218 that is a base station, as described herein).

Embodiments contemplated herein include a signal as described in or related to one or more elements of the method any of method 300, 400, 500, and 600.

Embodiments contemplated herein include a computer program or computer program product comprising instructions, wherein execution of the program by a processor is to cause the processor to carry out one or more elements of any of method 300, 400, 500, and 600. The processor may be a processor of a UE (such as a processor(s) 204 of a wireless device 202 that is a UE, as described herein) or a processor of a base station (such as a processor(s) 220 of a network device 218 that is a base station, as described herein). These instructions may be, for example, located in the processor and/or on a memory of the UE (such as a memory 206 of a wireless device 202 that is a UE, as described herein) or of a base station (such as a memory 222 of a network device 218 that is a base station, as described herein).

The inventive idea disclosed herein can be implemented in the following exemplary manners.
1. A method for operating a user equipment device (UE), the method comprising:
for one or more downlink control information (DCIs) received from a base station and for one or more multicast PDSCH receptions from the base station scheduled by the respective DCIs:
decoding a first DCI and a second DCI by using a first group identification (ID) to obtain a first downlink assignment index (DAI) and a second DAI respectively;
decoding a first PDSCH reception scheduled by the first DCI to generate a first Hybrid Automatic Repeat Request (HARQ) bit, and decode a second PDSCH reception scheduled by the second DCI to generate a second HARQ bit; and
arranging the first and the second HARQ bits for the first and the second PDSCH receptions in a first HARQ codebook to generate a first ACK/NACK feedback, wherein a first position of the first HARQ bit in the first HARQ codebook is indicated by a first counter DAI (C-DAI) included in the first DAI, and a second position of the second HARQ bit in the first HARQ codebook is indicated by a second C-DAI included in the second DAI.
2. The method of article 1, further comprising:
determining a size of the first HARQ codebook based on a first total DAI (T-DAI) included both in the first DAI and in the second DAI, wherein the first T-DAI indicates a total number of all DAIs for the first group ID within the K1 set.
3. The method of article 2, further comprising:
decoding a third DCI by using a second group ID to obtain a third DAI;
decoding a third PDSCH scheduled by the third DCI to generate a third HARQ bit;
determining a size of a second HARQ codebook based on a second total DAI (T-DAI) included in the third DAI; and
arranging a third HARQ bit for the third PDSCH reception in the second HARQ codebook, wherein the third position of the third HARQ bit in the second HARQ codebook is indicated by a third C-DAI included in the third DAI.
4. The method of article 2, further comprising:
determining if any position, 1) before the first position, 2) between the first position and the second position, and/or 3) after the second position, in the first HARQ codebook is empty without a HARQ bit, and arranging a NACK bit in that position when the determination is positive;
determine if a value N, which is equal to a value of a UL DAI minus a value of the first T-DAI, is greater than 0, and arrange N NACK bits in a HARQ codebook for a third group ID if the determination is positive, wherein the UL DAI indicates all PDSCH transmissions scheduled for the first and the third group IDs.
5. The method of article 1, wherein the first DAI is of 2 bits to serve as the first C-DAI.
6. The method of article 2, wherein the first DAI is of 4 bits; and the 2 MSBs thereof serve as the first C-DAI, and the 2 LSBs thereof serve as the first T-DAI, or vice versa.
7. The method of article 3, wherein one of the first or the second HARQ codebooks is appended to the other in an ascending order or a descending order of the first and the second group IDs.
8. The method of article 3, wherein any of the first or the second group ID is a corresponding Group RNTI (G-RNTI), the one or more DCI is of DCI Format 4_2, the HARQ codebooks are transmitted over PUCCH or PUSCH resources, and/or a higher layer parameter pdsch-HARQ-ACK-Codebook-Multicast=dynamic.
9. The method of article 1, further comprising:
monitor a fourth DCI which is to schedule a fourth PDSCH reception associated with the first group ID in a first HARQ process;
in response to determination of the fourth DCI not being detected, decode a fifth DCI by using the first group ID to obtain a fifth DAI, wherein the fifth DCI schedules a PDSCH reception in a next HARQ process with HARQ feedback disabled;
arranging a fourth HARQ bit for the fourth PDSCH reception in the first HARQ codebook, wherein a fourth position of the fourth HARQ bit in the first HARQ codebook is indicated by a fifth C-DAI included in the fifth DAI.
10. The method of article 2, wherein the first group ID is a group ID configured with a NACK-only feedback, and the first ACK/NACK feedback is generated by transforming a first NACK-only feedback to an ACK/NACK feedback, wherein the first NACK-only feedback is to be transmitted along with a second ACK/NACK feedback in a same first slot, the second ACK/NACK feedback being generated either for one or more PDSCH receptions associated with a third group ID or for one or more PDSCH receptions in a unicast service.
11. The method of article 10, wherein a type-2 HARQ codebook is applied to both the first and the second ACK/NACK feedbacks with a same priority; and/or wherein one of the first or the second ACK/NACK feedbacks is appended to the other in an ascending order or a descending order of the first and the third group IDs if the second ACK/NACK feedback is generated for one or more PDSCH receptions associated with the third group ID, or the first ACK/NACK feedback is appended to the second ACK/NACK feedback if the second ACK/NACK feedback is generated for one or more PDSCH receptions in the unicast service.
12. A method for operating a base station, the method comprising:
transmitting a first downlink control information (DCI) to a group of user equipment devices (UEs), wherein the first DCI is scrambled with a first group identification (ID) and includes a first downlink assignment index (DAI), and the first DCI is configured to schedule a first PDSCH transmission;
transmitting a second DCI to the group of UEs, wherein the second DCI is scrambled with the first group ID and includes a second DAI, and the second DCI is configured to schedule a second PDSCH transmission;
determining a first position of a first HARQ bit for the first PDSCH transmission in a first HARQ codebook based on a first C-DAI included in the first DAI, and a second position of the second HARQ bit for the second PDSCH transmission in the first HARQ codebook based on a second C-DAI included in the second DAI; and
decoding HARQ information received from a first UE in the group of UEs based on positions of respective HARQ bits.
13. The method of article 12, further comprising:
determining a size of the first HARQ codebook based on a first total DAI (T-DAI) included in both in the first DAI and in the second DAI, wherein the size of the first HARQ codebook is determined based on the first T-DAI, and wherein the first T-DAI indicates a total number of all DAIs for the first group ID within a K1 set.
14. The method of article 13, further comprising:
transmitting a third DCI to a group of UEs including the first UE, wherein the third DCI is scrambled with a second group ID and includes a third DAI, and the third DCI is configured to schedule a third PDSCH transmission;
determining a third position of a third HARQ bit for the third PDSCH transmission in a second HARQ codebook based on a third C-DAI included in the third DAI; and
decoding HARQ information received from the first UE in the group of UEs by further using the third position of the third HARQ bit.
15. The method of article 12, wherein the first DAI is of 2 bits to serve as the first C-DAI.
16. The method of article 13, wherein the first DAI is of 4 bits; and the 2 MSBs thereof serve as the first C-DAI, and the 2 LSBs thereof serve as the first T-DAI, or vice versa.
17. The method of article 14, wherein one of the first or the second HARQ codebooks is appended to the other in an ascending order or a descending order of the first and the second group IDs.
18. The method of article 14, wherein any of the first or the second group ID is a corresponding Group RNTI (G-RNTI), the one or more DCI is of DCI Format 4_2, the HARQ codebooks are received over PUCCH or PUSCH resources, and/or a higher layer parameter pdsch-HARQ-ACK-Codebook-Multicast=dynamic.
19. The method of article 12, further comprising:
transmitting a fourth DCI to the group of UEs in a first HARQ process with HARQ feedback disabled, wherein the fourth DCI is scrambled with the first group ID and includes a fourth DAI, and the fourth DCI is configured to schedule a fourth PDSCH transmission;
determining a fifth position of a fifth HARQ bit for a fifth PDSCH transmission in the first HARQ codebook based on a fourth C-DAI included in the fourth DAI, wherein a fifth DCI scheduling the fifth PDSCH transmission in a previous HARQ process was not received by the first UE.
20. The method of article 12, wherein the first group ID is a group ID configured with an ACK/NACK feedback or a NACK-only HARQ feedback.
21. A method for operating a user equipment device (UE), the method comprising: transforming a NACK-only feedback to an ACK/NACK feedback; and multiplexing the transformed ACK/NACK feedback with a scheduling request (SR) to obtain a multiplexed signal.
22. The method of article 21, further comprising:
applying PUCCH resources configured for unicast to the multiplexed signal;
applying PUCCH resources configured for multicast ACK/NACK feedback to the multiplexed signal; or dropping the transformed ACK/NACK feedback or the SR depending on priorities thereof.
23. The method of article 21, wherein the NACK-only feedback is configured to support more than two bits of NACK-only feedback, and the method further comprises sharing PUCCH resources with the SR based on a predefined PUCCH resource table.
24. The method of article 23, further comprising:
if configured with up to 4 transport blocks, dropping the SR or the NACK-only feedback depending priorities thereof, or share the PUCCH resources based on the PUCCH resource table; and/or
if configured with transforming the NACK-only feedback to the ACK/NACK feedback, multiplexing the SR and the transformed ACK/NACK feedback by using PUCCH Format 2, PUCCH Format 3, or PUCCH Format 4.
25. A method for operating a user equipment device (UE), the method comprising:
generating a NACK-only feedback for one or more PDSCH receptions associated with a first group identification (ID), wherein the NACK-only feedback is to be transmitted along with a first ACK/NACK feedback in a same first slot;
transforming the NACK-only feedback to a second ACK/NACK feedback; and
transmitting the first and the second ACK/NACK feedbacks in the first slot,
wherein the first ACK/NACK feedback is generated either for one or more PDSCH receptions associated with a second group ID or for one or more PDSCH receptions in a unicast service.
26. The method of article 25, wherein a type-1 HARQ codebook is applied to both the first and the second ACK/NACK feedbacks with a same priority, or a type-2 HARQ codebook is applied to both the first and the second ACK/NACK feedbacks with a same priority.
27. The method of article 26, wherein the type-1 HARQ codebook is determined by applying a union of a time domain resource allocation (TDRA) table.
28. The method of article 25, wherein one of the first or the second ACK/NACK feedbacks is appended to the other in an ascending order or a descending order of the first and the second group IDs if the second ACK/NACK feedback is generated for one or more PDSCH receptions associated with the second group ID, or the first ACK/NACK feedback is appended to the second ACK/NACK feedback if the second ACK/NACK feedback is generated for one or more PDSCH receptions in the unicast service.
29. An apparatus for operating a user equipment device (UE), the apparatus comprising a processor configured to cause the UE to perform operations of any of the method of articles 1 to 11 and 21 to 28.
30. An apparatus for operating a base station, the apparatus comprising a processor configured to cause the base station to perform operations of any of the method of articles 12 to 20.
31. A non-transitory computer-readable memory medium storing program instructions which, when executed by a computer system, cause implementation of operations of the method of any of articles 1 to 28.
32. A computer program product, comprising program instructions which, when executed by a computer, cause implementation of operations of the method of any of articles 1 to 28.
Proposal 1: If UE is configured with multiple G-RNTI and type-2 HAQR-ACK feedback
If type-2 codebook is configured for unicast and multicast, 4 bits in DAI field in DCI format 4_2, where the 2 MSB bits are the counter DAI and the 2 LSB bits are total DAI for the scheduled G-RNTI
   The total DAI is all the DAIs for the scheduled G-RNTI within the K1 set, i.e., the DL slots within the K1 set will feed back the HARQ-ACK bits in the same UL slot. The total DAI is the same for all slots in the K1 set.
Downlink assignment index—number of bits as defined in the following:
   4 bits if multicast multiple G-RNTIs are configured and the higher layer parameter pdsch-HARQ-ACK-Codebook-Multicast=dynamic, where the 2 MSB bits are the counter DAI and the 2 LSB bits are the total DAI for the scheduled G-RNTI;
   2 bits if single G-RNTI is configured in the DL for multicast and the higher layer parameter pdsch-HARQ-ACK-Codebook-Multicast=dynamic, where the 2 bits are the counter DAI;
0 bits otherwise.
Proposal 2: If Type-2 codebook is configured for unicast and multicast, and the HARQ-ACK bits are multiplexing on PUSCH, to solve the DCI missing issue, the followings are proposed
2 bit UL DAI are introduced for multicast in UL DCI Format 0_1/0_2 to indicates the total number of DL DAIs for all G-RNTIs
4 bits DAI in DCI format 4_2, where 2 MSB bits are the counter DAI and the 2 LSB bits are the total DAI for the scheduled G-RNTI
The total DAI is all the DAIs for the scheduled G-RNTI within the K1 set, i.e., the DL slots within the K1 set will feed back the HARQ-ACK bits in the same UL slot. The total DAI is the same for all slots in the K1 set
After cross check the UL DAI in and DL DAI (counter DAI, Total DAI), gNB would know which DL DCI is missed, whatever the missed DCI is the last DCI for a G-RNTI or not
Proposal 3: DAI field interpretation for type-2 HARQ codebook in case of HARQ feedback is disabled
Solution 1: If HARQ feedback is disabled by RRC signaling, the field is reserved, i.e., 0 bit. UE just ignore the DAI field. The values of C-DAI or T-DAI indicated by DAI does not impact codebook construction
Solution 2: The DAI field provides assistant information for codebook generation, the DAI in disabled HARQ process is the same as previous value of DAI of enabled HARQ process with the same G-RNTI.
   If the previous missed DCI is the last scheduled PDSCH with HARQ feedback, the DAI of disabled HARQ could make the UE aware the previous DCI is missed. Thus, the wrong codebook construction of issue 1 is avoided
Proposal 4: NACK-only HARQ feedback overlap with ACK/NACK
If more than one G-RNTIs are configured with NACK-only feedback, and other G-RNTI configured with ACK/NACK based feedback or feedback for unicast, PUCCH is overlapped in the same slot
   Alternative 1: NACK-only based feedback transforms to ACK/NACK based feedback and append to ACK/NACK feedback, in ascendent order of G-NRTI
      To counting how many ACK feedback for NACK-only based feedback,
         Option 1:2 bits are introduced as counter in DAI field of DCI format 4_2 for NACK-only feedback
         Option 2: 4 bits for NACK-only feedback in DCI Format 4_2, 2 MBS bits are the counter DAI and the 2 LSB bits are the total DAI for all G-RNTIs configured with NACK-only feedback
   Alternative 2: the codebook construction is the same as the ACK/NACK based feedback for all G-RNTIs
   Alternative 2-1: For NACK-only based feedback, gNB configure type-1 codebook or type-2 codebook
   Alternative 2-2: the codebook type configured for ACK/NACK based feedback is applied to NACK-only based feedback with the same priority
   Alternative 2-3: if NACK-only based feedback is configured, UE assume the type-1 (or type-2 codebook) is applied always
   Alternative 2-4: UE assume the same codebook type as unicast with the same priority
   For the type-1 codebook, the union of TDRA table is applied to determine the codebook
   For type-2 codebook, the multicast sub-codebook append to unicast codebook
Proposal 5: multiplexing NACK-only feedback with SR
For up to two HARQ bits, at least one bit is for NACK-based feedback (another HARQ bit could be from ACK/NACK feedback or from unicast feedback), if the PUCCH for HARQ-ACK is colliding with PUCCH transmission for SR
   Option1: first step, NACK-only based feedback transform to ACK/NACK based feedback. Second step, existing ACK and SR multiplexing scheme is applied
      Alt 1: The PUCCH resource configured for unicast is applied
      Alt 2: The PUCCH resource configured for multicast ACK/NACK feedback is applied
   Option 2: UE drops the SR
   Option 3: UE drops the HARQ-ACK bits transmission
   Option 4: up to UE implementation which transmission is dropped
For case of more than two bits of NACK-only colliding with SR
   Depending on gNB configuration that the NACK feedback is supporting up to 4 TBs or transform to ACK/NACK feedback
      If configured with up to 4 TBs, drop SR or NACK-only or define the PUCCH resource table for SR
      If configured with transforming to ACK/NACK bits, PUCCH Format 2/3/4 is used for the transmission per the legacy SR and HARQ-ACK multiplexing rule of Rel-15/16

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment device (UE), comprising:
one or more antennas configured to perform wireless communications;
a transceiver coupled to the one or more antennas; and
a processor coupled to the transceiver and configured to cause the UE to:
for one or more downlink control information (DCIs) received from a base station and for one or more multicast PDSCH receptions from the base station scheduled by the respective DCIs:
decode a first DCI and a second DCI by using a first group identification (ID) to obtain a first downlink assignment index (DAI) and a second DAI respectively;
decode a first PDSCH reception scheduled by the first DCI to generate a first Hybrid Automatic Repeat Request (HARQ) bit, and decode a second PDSCH reception scheduled by the second DCI to generate a second HARQ bit; and
arrange the first and the second HARQ bits for the first and the second PDSCH receptions in a first HARQ codebook to generate a first ACK/NACK feedback, wherein a first position of the first HARQ bit in the first HARQ codebook is indicated by a first counter DAI (C-DAI) included in the first DAI, and a second position of the second HARQ bit in the first HARQ codebook is indicated by a second C-DAI included in the second DAI.

2. The UE of claim 1, wherein the processor is further configured to cause the UE to:
determine a size of the first HARQ codebook based on a first total DAI (T-DAI) included both in the first DAI and in the second DAI, wherein the first T-DAI indicates a total number of all DAIs for the first group ID within the K1 set, wherein the K1 set is number of DL slots sending the HARQ-ACK bits in a same UL slot.

3. The UE of claim 2, wherein the processor is further configured to cause the UE to:
decode a third DCI by using a second group ID to obtain a third DAI;
decode a third PDSCH scheduled by the third DCI to generate a third HARQ bit;
determine a size of a second HARQ codebook based on a second total DAI (T-DAI) included in the third DAI; and
arrange a third HARQ bit for the third PDSCH reception in the second HARQ codebook, wherein the third position of the third HARQ bit in the second HARQ codebook is indicated by a third C-DAI included in the third DAI.

4-6. (canceled)

7. The UE of claim 3, wherein one of the first or the second HARQ codebooks is appended to the other in an ascending order or a descending order of the first and the second group IDs.

8. The UE of claim 3, wherein any of the first or the second group ID is a corresponding Group RNTI (G-RNTI), the one or more DCI is of DCI Format 4_2, the HARQ codebooks are transmitted over PUCCH or PUSCH resources, and/or a higher layer parameter pdsch-HARQ-ACK-Codebook-Multicast-dynamic.

9. (canceled)

10. The UE of claim 3, wherein the first group ID is a group ID configured with a NACK-only feedback, and the first ACK/NACK feedback is generated by transforming a first NACK-only feedback to an ACK/NACK feedback, wherein the first NACK-only feedback is to be transmitted along with a second ACK/NACK feedback in a same first slot, the second ACK/NACK feedback being generated either for one or more PDSCH receptions associated with a third group ID or for one or more PDSCH receptions in a unicast service.

11. The UE of claim 10, wherein a type-2 HARQ codebook is applied to both the first and the second ACK/NACK feedbacks with a same priority; and/or
wherein one of the first or the second ACK/NACK feedbacks is appended to the other in an ascending order or a descending order of the first and the third group IDs if the second ACK/NACK feedback is generated for one or more PDSCH receptions associated with the third group ID, or the first ACK/NACK feedback is appended to the second ACK/NACK feedback if the second ACK/NACK feedback is generated for one or more PDSCH receptions in the unicast service.

12. The UE of claim 10, wherein the HARQ codebook type for first ACK/NACK feedback is the same as the HARQ codebook type for second ACK/NACK feedback, or
the HARQ codebook type for first ACK/NACK feedback is the same as the HARQ codebook type of unicast PDSCH.

13. A base station, comprising:
one or more antennas configured to perform wireless communications;
a transceiver coupled to the one or more antennas; and
a processor coupled to the transceiver and configured to cause the base station to:
transmit a first downlink control information (DCI) to a group of user equipment devices (UEs), wherein the first DCI is scrambled with a first group identification (ID) and includes a first downlink assignment index (DAI), and the first DCI is configured to schedule a first PDSCH transmission;
transmit a second DCI to the group of UEs, wherein the second DCI is scrambled with the first group ID and includes a second DAI, and the second DCI is configured to schedule a second PDSCH transmission;
determine a first position of a first HARQ bit for the first PDSCH transmission in a first HARQ codebook based on a first C-DAI included in the first DAI, and a second position of the second HARQ bit for the second PDSCH transmission in the first HARQ codebook based on a second C-DAI included in the second DAI; and
decode HARQ information received from a first UE in the group of UEs based on positions of respective HARQ bits.

14. The base station of claim 13, wherein the processor is further configured to cause the base station to:
determine a size of the first HARQ codebook based on a first total DAI (T-DAI) included in both in the first DAI and in the second DAI, wherein the size of the first HARQ codebook is determined based on the first T-DAI, and wherein the first T-DAI indicates a total number of all DAIs for the first group ID within a K1 set.

15. The base station of claim 14, wherein the processor is further configured to cause the base station to:
transmit a third DCI to a group of UEs including the first UE, wherein the third DCI is scrambled with a second group ID and includes a third DAI, and the third DCI is configured to schedule a third PDSCH transmission;
determine a third position of a third HARQ bit for the third PDSCH transmission in a second HARQ codebook based on a third C-DAI included in the third DAI; and
decode HARQ information received from the first UE in the group of UEs by further using the third position of the third HARQ bit.

16-17. (canceled)

18. The base station of claim 15, wherein one of the first or the second HARQ codebooks is appended to the other in an ascending order or a descending order of the first and the second group IDs.

19. The base station of claim 15, wherein any of the first or the second group ID is a corresponding Group RNTI (G-RNTI), the one or more DCI is of DCI Format 4_2, the HARQ codebooks are received over PUCCH or PUSCH resources, and/or a higher layer parameter pdsch-HARQ-ACK-Codebook-Multicast-dynamic.

20. The base station of claim 13, wherein the processor is further configured to cause the base station to:
transmit a fourth DCI to the group of UEs in a first HARQ process with HARQ feedback disabled, wherein the fourth DCI is scrambled with the first group ID and includes a fourth DAI, and the fourth DCI is configured to schedule a fourth PDSCH transmission;
determine a fifth position of a fifth HARQ bit for a fifth PDSCH transmission in the first HARQ codebook based on a fourth C-DAI included in the fourth DAI, wherein a fifth DCI scheduling the fifth PDSCH transmission in a previous HARQ process was not received by the first UE.

21. The base station of claim 13, wherein the first group ID is a group ID configured with an ACK/NACK feedback or a NACK-only feedback.

22. A user equipment device (UE), comprising:
one or more antennas configured to perform wireless communications;
a transceiver coupled to the one or more antennas; and
a processor coupled to the transceiver and configured to cause the UE to:
transform a NACK-only feedback to an ACK/NACK feedback; and
multiplex the transformed ACK/NACK feedback with a scheduling request (SR) to obtain a multiplexed signal.

23. The UE of claim 22, wherein the processor is further configured to cause the UE to:
apply PUCCH resources configured for unicast to the multiplexed signal;
apply PUCCH resources configured for multicast ACK/NACK feedback to the multiplexed signal; or
drop the transformed ACK/NACK feedback or the SR depending on priorities thereof.

24. The UE of claim 22, wherein the NACK-only feedback is configured to support more than two bits of NACK-only feedback, and the processor is further configured to cause the UE to:
share PUCCH resources with the SR based on a predefined PUCCH resource table.

25. The UE of claim 24, wherein the processor is further configured to cause the UE to:
if configured with up to 4 transport blocks, drop the SR or the NACK-only feedback depending priorities thereof, or share the PUCCH resources based on the PUCCH resource table; and/or
if configured with transforming the NACK-only feedback to the ACK/NACK feedback, multiplex the SR and the transformed ACK/NACK feedback by using PUCCH Format 2, PUCCH Format 3, or PUCCH Format 4.

26-29. (canceled)
